(19) United States
(12) Patent Application Publication
(10) Pub. No.: US 2009/0196538 A1
(43) Pub. Date: Aug. 6, 2009

(54) Linear Guideway with a Negative Pressure Type Dust Absorption Structure

(76) Inventors: Pzung-Cheng LIOU, Taichung (TW); Chi-Pin CHOU, Taichung (TW)

Correspondence Address: Dr. BANGER SHIA, 102 Lindencrest Ct., Sugar Land, TX, 77479-5201, US

(21) Appl. No.: 12/025,698

(22) Filed: Feb. 4, 2008

(51) Int. Cl. F16C 29/08

(52) U.S. Cl. 384/7

(57) ABSTRACT

A linear guideway with a negative pressure type dust absorption structure comprises a linear guideway and a negative pressure type dust absorption structure. The linear guideway includes a sliding block and a sliding seat. The sliding block is movably disposed on the sliding seat. The negative pressure type dust absorption structure is disposed on the sliding block and includes at least one guiding passage having at least one inlet and one outlet. The outlet is connected to a negative pressure source, such that the suction is produced, so as to absorb dust from the inlet of the guiding passage.

### BACKGROUND OF THE INVENTION

1. Field of the Invention

The present invention relates to a linear guideway, and more particularly to a linear guideway with a negative pressure type dust absorption structure which is used in dust-free work place.

2. Description of the Prior Art

With the rapid development of the automation industry, manpower is gradually replaced by tool machines, and linear guideway is one of the indispensable components for moving the tool machines. Referring to FIG. 1, the conventional linear guideway 90 comprises a sliding block 91 and a sliding seat 92. The sliding block 91 is movably assembled on the sliding seat 92. However, such a conventional linear guideway 90 still has the following disadvantages:

When the sliding block 91 moves on the sliding seat 92, the friction force can be reduced only by using lubricating oil, but the temperature of the lubricating oil will be increased and the lubricating oil will be deteriorated after being rubbed against by the sliding block 91 and the sliding seat 92 for a long period of time, and the oil deterioration is one of the main reasons to produce dust. The semiconductor industry has a particularly strict requirement for the dust-fall amount in work place, because even the micro-particle may cause short circuit and damage to the products, reduce the reliability, increase the defective rate of the products and waste the manufacturing cost.

To solve the above-mentioned disadvantages, an air bearing is developed, however, such an air bearing is high cost. If the air bearing is mounted on the linear guideway, the cost will be increased.

Thereby, a dust-proof strip and a dust-proof cover are developed, however, such a dust-proof strip and a dust-proof cover will contact the sliding block or the sliding seat to cause friction, so the problem of producing dust cannot be solved either.

Therefore, finding a linear guideway with a negative pressure type dust absorption structure to effectively process the dust and chips of the linear guideway to meet the requirement of the dust-free work place has become an important issue for the manufacturers.

The present invention has arisen to mitigate and/or obviate the afore-described disadvantages.

### SUMMARY OF THE INVENTION

The primary objective of the present invention is to provide a linear guideway with a negative pressure type dust absorption structure which can absorb dust and chips produced by the linear guideway by the negative pressure suction.

To achieve the objective of the present invention, the linear guideway with a negative pressure type dust absorption structure is connected to a negative pressure source and comprises a linear guideway and a negative pressure type dust absorption structure.

The linear guideway includes a sliding block and a sliding seat. The sliding block is movably disposed on the sliding seat.

The negative pressure type dust absorption structure includes a cover disposed outside the sliding block. At least one adsorption portion and one guiding portion are disposed on the cover, and at least one guiding passage having at least one inlet and one outlet is disposed in the cover. The inlet is connected to the adsorption portion, and the outlet is connected to the guiding portion and a negative pressure source. At least one assembling portion is disposed on the outer side of the cover opposite to an outer side of the sliding block, such that the cover is assembled to the sliding block of the linear guideway via the assembling portion, enabling the cover to move on the sliding seat along with the sliding block of the linear guideway. In addition, the suction will be produced by the negative pressure source, so as to absorb dust and chips from the inlet of the guiding passage.

The above-mentioned negative pressure type dust absorption structure is disposed in the sliding block and includes at least one guiding passage having at least one inlet and one outlet. The inlet of the guiding passage is disposed in a bottom of the sliding block, and the outlet of the guiding passage is disposed in both ends of the sliding block. The outlet is connected to the negative pressure source, and the sliding block of the linear guideway is moved on the sliding seat. In addition, the suction will be produced by the negative pressure source, so as to absorb dust and chips from the inlet of the guiding passage.

By the above-mentioned structure, the present invention has the following advantages:

Firstly, the linear guideway processes the dust or chips by the suction produced by the negative pressure type dust absorption structure, so as to reduce the foreign objects deposited on the work place and to prevent the products from being damaged by the foreign objects, thus improving the quality of the products.

Secondly, with the negative pressure type dust absorption structure, it is unnecessary to dispose an air bearing on the linear guideway, such that the cost is reduced.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an assembly perspective view of a conventional linear guideway;

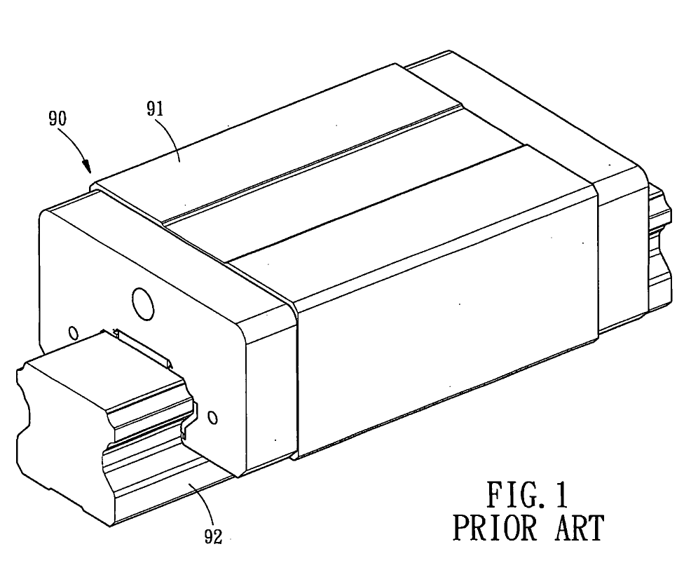

FIG. 2 is an assembly perspective view of a linear guideway with a negative pressure type dust absorption structure in accordance with a first embodiment of the present invention;

FIG. 3 is an assembly perspective view of a linear guideway with a negative pressure type dust absorption structure in accordance with a second embodiment of the present invention;

FIG. 4 is an assembly perspective view of a linear guideway with a negative pressure type dust absorption structure in accordance with a third embodiment of the present invention; and

FIG. 5 is an assembly perspective view of a linear guideway with a negative pressure type dust absorption structure in accordance with the present invention.

### DETAILED DESCRIPTION OF THE PREFERRED EMBODIMENTS

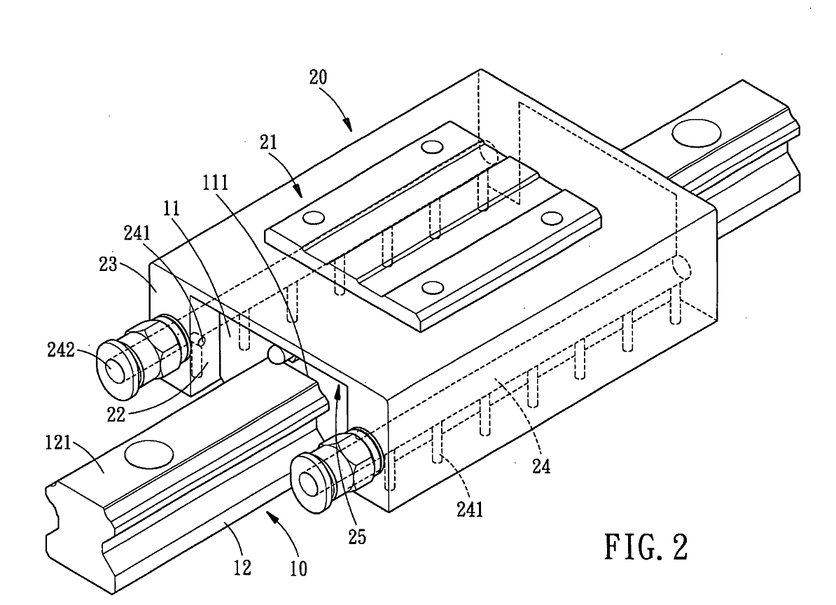

Referring to FIG. 2, a linear guideway 10 in accordance with the present invention comprises a sliding block 11 and a sliding seat 12. One side of the sliding block 11 is formed with a sliding portion 111. One side of the sliding seat 12 is formed with a guide rail 121, and the sliding portion 111 of the sliding block 11 is formed corresponding to the shape of the guide rail 121 of the sliding seat 12. The sliding block 11 is assembled to the guide rail 121 of the sliding seat 12 via the sliding portion 111.

A negative pressure type dust absorption structure 20 in accordance with the present invention is described in the following two states:

One state is that the negative pressure type dust absorption structure 20 is disposed outside the sliding block 11 of the linear guideway 10.

The negative pressure type dust absorption structure 20 includes a reverse U-shaped cover 21. At least one adsorption portion 22 is disposed on an inner surface of the cover 21, and at least one guiding portion 23 is disposed on an outer side of the cover 21. At least one guiding passage 24 having at least one inlet 241 and one outlet 242 is disposed in the cover 21. The inlet 241 is connected to the adsorption portion 22, and the outlet 242 is connected to the guiding portion 23. The adsorption portion 22 of the cover 21 can be disposed with at least one inlet 241, and the guiding portion 23 of the cover 21 can be disposed with at least one outlet 242. The outlet 242 is connected to a negative pressure source (such as a dust collector or a vacuum pump), that is, the inlet 241 is in communication with the outlet 242 to form the guiding passage 24. At least one assembling portion 25 is disposed on the outer side of the cover 21 opposite to an outer side of the sliding block 11, such that the cover 21 is assembled to the sliding block 11 of the linear guideway 10 via the assembling portion 25, enabling the cover 21 to move on the sliding seat 12 along with the sliding block 11 of the linear guideway 10.

Referring to FIG. 2, the negative pressure type dust absorption structure 20 in accordance with a first embodiment of the present embodiment is shown. The cover 21 is mounted on one side of the sliding block 11. Both inner sides and an inner bottom of the cover 21 are formed with an adsorption portion 22, respectively. The guiding portion 23 is disposed on an outer surface of one end of the cover 21. The inlet 241 and the outlet 242 of the guiding passage 24 are in communication with the adsorption portions 22 and the guiding portion 23, respectively. The assembling portion 25 is formed on the inner surface of a middle portion of the cover 21 adjacent to the adsorption portions 22, and the cover 21 is assembled to the sliding block 11 of the linear guideway 10 via the assembling portion 25.

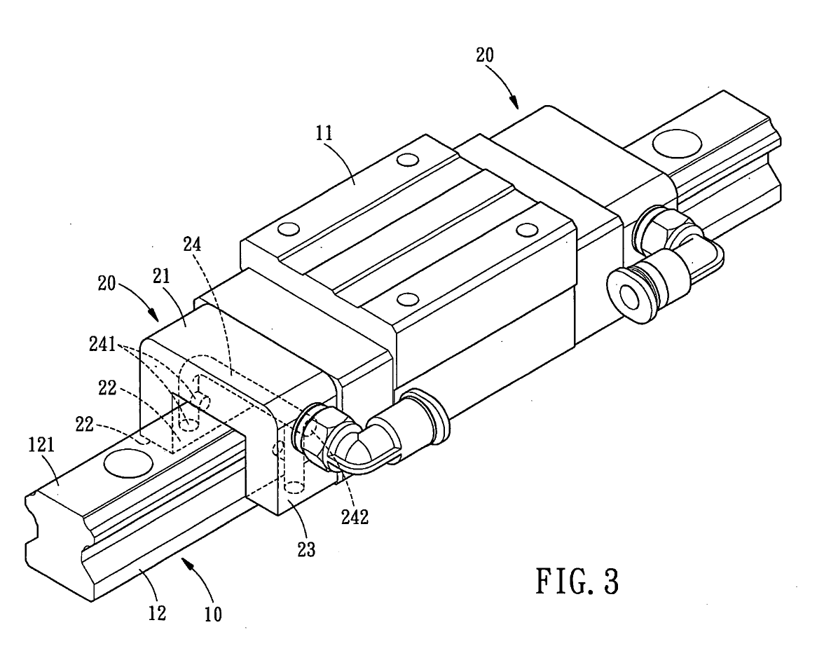

Referring to FIG. 3, the negative pressure type dust absorption structure 20 in accordance with a second embodiment of the present embodiment is shown. The cover 21 is mounted on both ends of the sliding block 11. The inner surface and the inner bottom of the cover 21 are formed with an adsorption portion 22, respectively. The guiding portion 23 is disposed on the outer surface of one end of the cover 21. The inlet 241 and the outlet 242 of the guiding passage 24 are in communication with the adsorption portion 22 and the guiding portion 23, respectively. The assembling portion 25 is formed at one side of the cover 21, and the cover 21 is assembled to both ends of the sliding block 11 of the linear guideway 10 via the assembling portion 25.

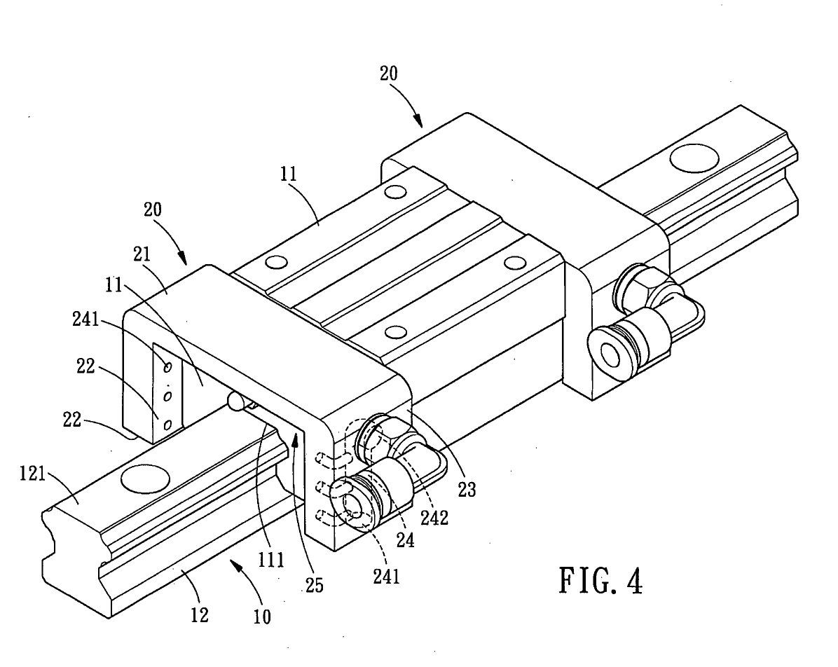

Referring to FIG. 4, the negative pressure type dust absorption structure 20 in accordance with a third embodiment of the present embodiment is shown. The cover 21 is mounted on both ends of the sliding block 11. The inner surface and the inner bottom of the cover 21 are formed with the adsorption portion 22, respectively The guiding portion 23 is disposed on the outer surface of one end of the cover 21.

The inlet 241 and the outlet 242 of the guiding passage 24 are in communication with the adsorption portion 22 and the guiding portion 23, respectively. One side and the inner surface of the cover 21 are formed with assembling portions 25 which is located adjacent to the adsorption portions 22 formed on both sides of the inner surface of the cover 21, and the cover 21 is assembled to both ends of the sliding block 11 of the linear guideway 10 via the assembling portions 25.

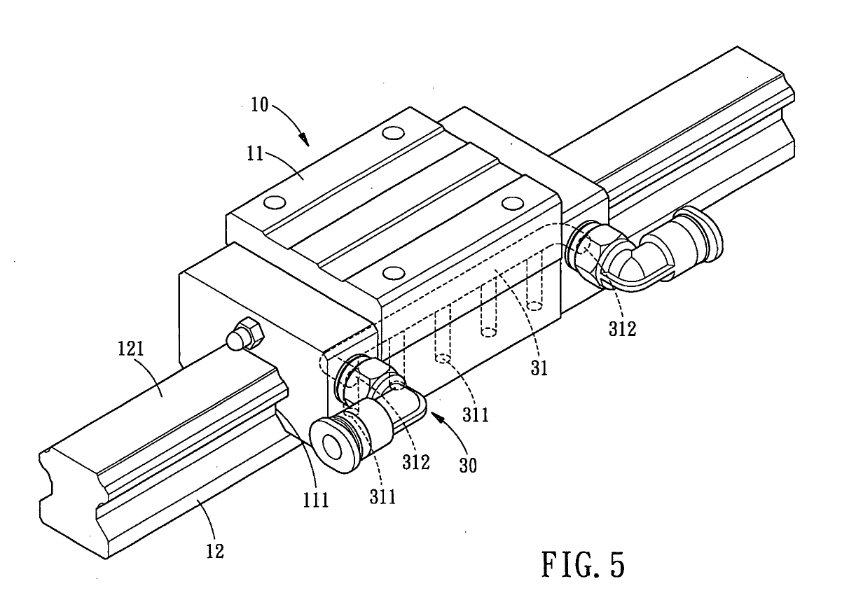

Referring to FIG. 5, the other state is that the negative pressure type dust. absorption structure 30 is disposed in the sliding block 11 of the linear guideway 10.

The negative pressure type dust absorption structure 30 includes at least one guiding passage, 31 having at least one inlet 311 and one outlet 312. Since the sliding portion 111 of the sliding block 11 contacts the guide rail 121 of the sliding seat 12, it is not a suitable portion for the inlet 311. Thereby, the inlet 311 of the guiding passage 31 is disposed in the bottom at both sides of the sliding block 11, and the outlet 312 of the guiding passage 31 is disposed in the outer surfaces on both sides of 20 the sliding block 11. That is, the inlet 311 is in communication with the outlet 312 to form the guiding passage 31.

To summarize, a linear guideway with a negative pressure type dust absorption structure of the present invention includes a linear guideway and a negative pressure type dust absorption structure. The linear guideway includes a sliding block and a sliding seat. The sliding block is movably disposed on the sliding seat. The negative pressure type dust absorption structure is disposed at the sliding block and includes at least one guiding passage having at least one inlet and one outlet. The outlet is connected to a negative pressure source, such that the suction is produced, so as to absorb dust from the inlet of the guiding passage.

While we have shown and described various embodiments in accordance with the present invention, it should be clear to those skilled in the art that further embodiments may be made without departing from the scope of the present invention.

What is claimed is:

1. A linear guideway with a negative pressure type dust absorption structure cooperating with a negative pressure source, comprising:
a linear guideway having a sliding block and a sliding seat, the sliding block being movably disposed on the sliding seat; and
a negative pressure type dust absorption structure having a cover disposed outside the sliding block, at least one adsorption portion and one guiding portion being disposed on the cover, at least one guiding passage having at least one inlet and one outlet being disposed in the cover, the inlet of the guiding passage being connected to the adsorption portion, the outlet of the guiding passage being connected to the guiding portion and the negative pressure source, at least one assembling portion being disposed on an outer side of the cover opposite to an outer side of the sliding block, such that the cover is assembled to the sliding block of the linear guideway via the assembling portion, enabling the cover to move on the sliding seat along with the sliding block of the linear guideway, and a suction being produced by the negative pressure source, so as to absorb dust and chips from the inlet of the guiding passage.

2. The linear guideway with a negative pressure type dust absorption structure as claimed in claim 1, wherein the adsorption portion of the negative pressure type dust absorption structure is formed on an inner surface and an inner bottom of the cover, the guiding portion of the negative pressure type dust absorption structure is disposed on an outer surface of one end of the cover, the inlet and the outlet of the guiding passage are in communication with the adsorption portion and the guiding portion, respectively, the assembling portion of the cover is formed on the inner surface of a middle portion of the cover adjacent to the adsorption portion, and the assembling portion of the cover is assembled to the sliding block of the linear guideway.

3. The linear guideway with a negative pressure type dust absorption structure as claimed in claim 1, wherein the adsorption portion of the negative pressure type dust absorption structure is formed on an inner surface and an inner bottom of the cover, the guiding portion of the negative pressure type dust absorption structure is disposed on an outer surface of one end of the cover, the inlet and the outlet of the guiding passage are in communication with the adsorption portion and the guiding portion, respectively, the assembling portion of the cover is formed on the outer surface of one side of the cover, and the assembling portion of the cover is assembled to both ends of the sliding block of the linear guideway.

4. The linear guideway with a negative pressure type dust absorption structure as claimed in claim 1, wherein the adsorption portion of the negative pressure type dust absorption structure is formed on an inner surface and an inner bottom of the cover, the guiding portion of the negative pressure type dust absorption structure is disposed on an outer surface of one end of the cover, the inlet and the outlet of the guiding passage are in communication with the adsorption portion and the guiding portion, respectively, one side and the inner surface of the cover are formed with assembling portion which is located adjacent to the adsorption portion formed on the inner surface of the cover, and the assembling portion of the cover is assembled to both ends of the sliding block of the linear guideway.

5. A linear guideway with a negative pressure type dust absorption structure cooperating with a negative pressure source, comprising:
a linear guideway having a sliding block and a sliding seat, the sliding block being moveably disposed on the sliding seat; and
a negative pressure type dust absorption structure disposed in the sliding block of the linear guideway and including at least one guiding passage having at least one inlet and one outlet, the inlet of the guiding passage being disposed in a bottom of the sliding block, the outlet of the guiding passage being disposed in both ends of the sliding block, the outlet of the guiding passage being connected to the negative pressure source, the sliding block of the linear guideway being moved on the sliding seat, and a suction being produced by the negative pressure source, so as to absorb dust and chips from the inlet of the guiding passage.
